(19) United States
(12) Patent Application Publication
(10) Pub. No.: US 2024/0021352 A1
(43) Pub. Date: Jan. 18, 2024

(54) MAGNETIC SIGNAL DEVICE FOR MEASURING THE MOVEMENT AND/OR THE POSITION OF A COMPONENT OF A DRIVE MACHINE

(71) Applicant: Miba eMobility GmbH, Laakirchen (AT)

(72) Inventor: Werner PESSENHOFER, Vasoldsberg (AT)

(73) Assignee: Miba eMobility GmbH, Laakirchen (AT)

(21) Appl. No.: 18/267,210

(22) PCT Filed: Dec. 14, 2021
(86) PCT No.: PCT/AT2021/060468

§ 371 Date: Jun. 14, 2023

(30) Foreign Application Priority Data
Dec. 15, 2020 (AT) A 51088/2020

(51) Int. Cl. H01F 10/12; G01D 5/14; H01F 41/14

(52) U.S. Cl. CPC H01F 10/126; G01D 5/145; H01F 41/14

(57) ABSTRACT

A magnetic signal device for measuring the movement and/or the position of a component of a drive machine has a supporting structure and a hard-magnetic layer applied on the supporting structure, wherein the hard-magnetic layer is applied via hollow cathode flow sputtering and/or electroplating and/or PVD and/or CVD and/or plasma spraying and x % by mass of the hard-magnetic layer consist of NdFeB and/or Co₅Sm and/or Co₂Sm₁₇ and/or Co₅Sm and/or Co₂Sm₁₇ and the hard-magnetic layer has a magnetic remanence of 0.3 T to 1.3 T in its scanning region.

The invention relates to a magnetic signal device for measuring the movement and/or position of a component of a drive machine.

The demands placed on today's absolute positioning systems in terms of measuring accuracy, size and also costs often differ significantly, but are becoming increasingly stringent.

Rotary encoders are usually used to detect angular changes on rotating shafts. A distinction is made between incremental encoders for determining speed or direction and absolute encoders for determining the absolute position. For this purpose, either optical scanning methods or methods based on magnetic sensors in connection with pole wheels are used.

The most commonly used measuring method for high-precision applications is optical or photoelectric scanning A light beam generated by a light source, usually an infrared light emitting diode, is guided through an optical system, in particular a condenser, a material measure, in particular a line grating, and a scanning plate, in particular an aperture, onto a photo-optical component, preferably a photodiode. By rotating the slitted disc, the light beam between the LED and the sensor is periodically modulated, allowing the sensor to determine speed and position.

However, the optical measuring method is fundamentally sensitive to environmental influences such as shock and vibration loads, dirt, temperature fluctuations and moisture. Although these disadvantages can be compensated for by special housing designs, the necessary housing designs for optical encoders lead to certain limitations in the mounting options. With the size of the shaft diameters, the costs for the encoder housing and the required ball bearings increase disproportionately, so that economically viable solutions are hardly possible for shaft diameters of 200 millimetres and more.

As an alternative, rotary encoders working with a magnetic measuring method are available. Due to their insensitivity to shock and vibration as well as to dirt, temperature fluctuations and moisture, magnetic encoders can be used especially where the service life of optical encoders is limited despite elaborate protective housings. These are areas of application in which the encoders are exposed to high temperatures, temperature fluctuations, dirt and dust pollution and/or exposure/contamination with chemicals and solvents.

The magnetic pitch of a pole wheel and/or encoder mounted on the rotating shaft is the signal generator for a sensor. Such an encoder is known, for example, from EP1030181A2. The electronics are integrated in the scanning head with a high degree of protection and may be completely encapsulated if required. Thanks to the two-part system design with pole wheel and scanning head, magnetic encoders can be used without a complex protective housing and additional ball bearings; this means that an almost wear-free solution with a very long service life can be realised. Furthermore, such systems do not require a free shaft end for installation and are therefore well suited for integration in electric motors, for example in electric cars. The disclosure DE102016218930A1 shows another such product. Alternatively, the disclosure DE102018217274A1, for example, shows the production of a ring of sintered partial magnets, each connected to polymer-based intermediate pieces.

The current production methods for hard-magnetic layers consist of polymer composites and have limitations in their applicability. In particular, the limited durability and resistance to greases and oils as well as compromises regarding the accuracy of such layers known in the prior art make it impossible to use such layers for high-performance applications in the prior art.

It is therefore an object of the present invention to develop a magnetic signal device that remedies these disadvantages and advances the state of the art.

This technical problem is solved by a magnetic signal device according to claim 1.

According to a particular embodiment, a magnetic signal device is provided for measuring the position of a rotating component of a drive machine, the signal device being coupled in a rotationally fixed manner to the component of the drive machine and the signal device having a supporting element and a hard-magnetic layer deposited on the supporting element from a gas phase directly on the supporting element, wherein at least 75% by weight, preferably at least 85% by weight, particularly preferably at least 90% by weight, based on the composition of the hard-magnetic layer, of the hard-magnetic layer consist of one or more of the following compounds: NdFeB and/or Co₅Sm and/or Co₂Sm₁₇, and the hard-magnetic layer has a magnetic remanence of 0.3 T to 1.3 T in its scanning range and the hard-magnetic layer has a magnetic structure in the direction of rotation, so that, depending on the angle of rotation of the component, the magnetic structure, for example the magnetic field strength and/or orientation at different heights, can be measured on the hard-magnetic layer via a sensor in order to enable conclusions to be drawn about the rotation and/or position of the component.

The pole wheels according to the invention are suitable for use at very high speeds, since the hard-metallic layer deposited from the gas phase makes it possible to achieve a high adhesion strength of the layer to the supporting element. Furthermore, the hard-magnetic layer, which is deposited from the gas phase directly onto the supporting element, is very resistant to oils and greases. The magnetic layers known from the prior art or obvious to the skilled person are characterised by processes for thermal spraying, back-injection or injection moulding of mixtures of polymer magnetic powder. In contrast, in the present invention, the hard-magnetic layer itself is deposited onto a substrate by means of deposition from a gas phase, for example by a hollow cathode gas flow method and/or a PVD method. The pole wheels used in the state of the art to date have a magnetically effective component in the form of a composite layer consisting of a polymer matrix with incorporated magnetic powder, usually made of ferritic material. Although these layers are inexpensive to produce, these polymer-based layers only have a positional accuracy of +/−1° and are not applicable above a temperature of >120° C. The achievable accuracy of the layer thickness is not better than +/−40 μm due to the production process.

Furthermore, they are vulnerable to oils and greases that are often used in fast rotating parts and systems that need to be cooled, which means that the necessary service life is not achieved. Another disadvantage is that these composite solutions can only be used for rotational speeds up to a maximum of approx. 10000 to 15000 rpm (depending on the diameter), as the adhesive strengths are not sufficient for higher centrifugal forces.

Thus, magnetic encoders are limited in terms of precision and speed as well as in terms of operating temperature and service life. With regard to the constantly increasing precision required in the future in the areas of Industry 4.0, autonomous driving and the control of electric motors (rotor), there are therefore limits to the magnetic incremental and absolute encoders known from the state of the art.

It was therefore an object of the present invention to develop a magnetic signal device that remedies these disadvantages and advances the state of the art.

According to a particular embodiment of the invention, the magnetic signal device has a supporting element and/or a supporting structure and a hard-magnetic layer without polymer content applied to the supporting element and/or the supporting structure, wherein the hard-magnetic layer is applied via at least one of the processes according to hollow cathode gas flow sputtering and/or hollow cathode sputtering and/or electroplating and/or PVD and/or CVD and/or plasma spraying, whereby the hard-magnetic layer consists of at least 75% by weight of one or more of the following compounds such as NdFeB and/or CosSm and/or Co₂Sm₁₇, in particular with/without doping or alloying with further elements such as, for example, Fe, Cu, Zr, and the hard-magnetic layer has a magnetic remanence of 0.1 T to 1.3 T in its scanning range. A key feature of the present invention is the absence of a polymer component (both elastomers and thermoplastics), as well as the presence of a purely metallic alloy layer. According to a particular embodiment of the invention, a maximum operating temperature (also long-term) of up to 250° C. is thus possible. This is not possible with the products taught in the state of the art. In DE 10 2016 218 930 A1, for example, a PVD, electroplating or vapour deposition method is used to apply a metal layer (“6” in FIG. 5) to a produced magnetic component made of polymer composite material. The magnetically active layer is produced by an injection moulding method and does not have a metallic magnetic component as in the inventive product presented, which was produced in particular by PVD or hollow cathode gas flow sputtering.

According to a particular embodiment of the invention, the hard-magnetic layer has an average thickness of between 10 and 100 μm, preferably more than 15 μm, particularly preferably more than 25 μm or between 25 μm and 60 μm, in its scanning region.

Various physical vapour deposition methods, in particular CVD (Chemical Vapour Deposition) and PVD (Physical Vapour Deposition) methods, are known from the prior art. In the field of PVD methods, for example, it is possible to generate ions via a glow discharge of a hollow cathode and to apply or sputter the ions generated in this way onto a surface. With hollow cathode sputtering, the workpiece to be coated is coated directly. If a gas, for example a noble gas such as argon, flows through the hollow cathode, this is called hollow cathode gas flow sputtering. The gas flow transports the material to the substrate. In plasma spraying, a suitable powder is melted in a plasma, in particular generated by an electric arc, and projected onto a substrate.

According to an exemplary embodiment, the hard-metallic layer, produced for example by means of PVD, CVD and/or hollow cathode sputtering, has a crystallinity of at least 50%, preferably at least 75%.

According to a particular embodiment of the invention, the hard-magnetic layer in the scanning region has an average thickness of between 15 and 80 μm, preferably between 25 and 60 μm. The layer thickness can be adjusted with a precision of less than or equal to +/−0.2 μm, in particular less than or equal to +/−0.1 μm, whereby the precision is decisively improved compared to the state of the art.

Due to the particularly high aspect ratio between layer thickness and magnetic pole width, the present invention exhibits outstanding properties, especially for in-plane directed magnetisation.

According to a particular embodiment of the invention, the supporting structure is provided of a ceramic material.

According to a particular embodiment of the invention, the supporting structure is provided of a metallic material.

According to a particular embodiment of the invention, a further layer, preferably with an average thickness of up to 10 μm, is provided over the hard-magnetic layer in the scanning area as a protective layer to protect the hard-magnetic layer.

According to a particular embodiment of the invention, the hard-magnetic layer in the scanning region contains further alloying elements from the series of transition metals, preferably Fe and/or Zr and/or Cu.

According to a particular embodiment, the hard-metallic layer has a composition with, based on the composition of the hard-metallic layer, up to 10% by weight of alloying elements.

According to a particular embodiment of the invention, the magnetic signal device is configured as a rotationally symmetrical pole wheel.

According to a particular embodiment of the invention, the magnetic signal device is configured as a rotationally symmetrical encoder.

According to a particular embodiment of the invention, an angular accuracy of less than or equal to +−0.1° between the differently magnetisable regions is achievable when the hard-magnetic layer is magnetised. This means that the structure of the magnetisation can be realised very finely.

According to one embodiment, the invention is characterised by a magnetic detection device with a magnetic signal device according to any one of the preceding claims and a sensor unit with a sensor working with a XMR and/or Hall measurement method.

An XMR sensor is a sensor that works magnetoresistively, i.e. the sensor changes its resistance under the influence of the magnetic flux. So-called AMR, GMR and TMR sensors are known from the state of the art and are subsumed under XMR sensors.

According to a particular embodiment of the invention, the sensor and the magnetic signal device have a resolution of 10 to 20 bits, in particular on one or more tracks.

According to one embodiment, the invention is further characterised by a detection device according to claim 11.

According to a particular embodiment, the magnetic detection device has, in addition to the signal device, a sensor unit with a sensor, the sensor being working with a XMR and/or Hall measuring method.

According to a particular embodiment, a distance of between 0.1 mm and 3 mm is provided between the sensor and the magnetic signal device.

According to a particular embodiment, the sensor and the magnetic signal device have a resolution of 10 to 20 bits, in particular on one or more tracks.

According to a further embodiment, the invention is characterised by a method for producing a magnetic signal device according to claim 14. According to a particular embodiment, the hard-magnetic layer is applied directly from the gas phase to the supporting element of the signal device via one of the following processes: hollow cathode gas flow sputtering and/or hollow cathode sputtering and/or electroplating and/or PVD method and/or CVD method and/or plasma spraying.

The invention is explained below with reference to several non-limiting schematic figures. In the drawings:

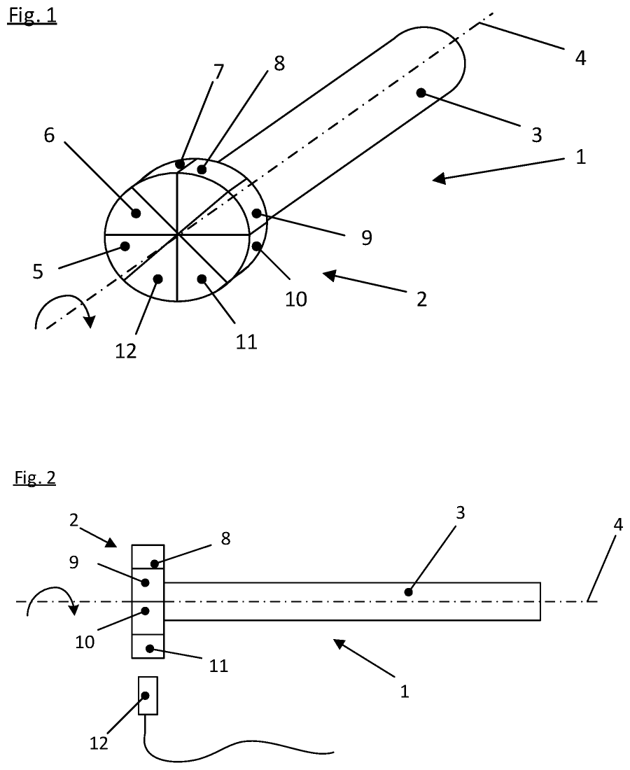

FIG. 1 is a schematic perspective view of a magnetic signal device,

FIG. 2 is a schematic view of a magnetic detection device according to the invention in a plan view,

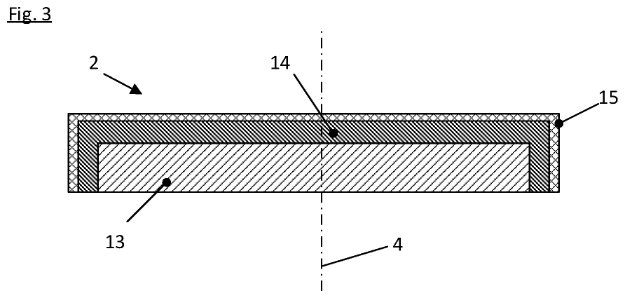

FIG. 3 is a sectional view of a part of a magnetic signal device.

FIG. 1 shows a schematic representation of a magnetic signal device 1. The magnetic signal device 1 has a rotationally symmetrical pole wheel 2. This pole wheel 2 is non-rotatably connected to a shaft 3. The shaft 3 rotates around an axis of rotation 4 and is connected, for example, to a gearbox or a drive machine (not shown). Thus, the rotation and/or position of the shaft 3 can be measured with the pole wheel 2.

As can be further seen in FIG. 1, the pole wheel has corresponding sections 5, 6, 7, 8, 9, 10, 11, 12, which are provided with a hard-magnetic layer with alternating magnetisation as magnetic poles. The hard-magnetic layer is magnetised via a suitable magnetisation device. As shown in FIG. 1 and FIG. 2, the hard-magnetic layer is arranged on the front surface of the pole wheel as well as on the radial circumferential surface. In FIG. 2, the individual poles 8, 9, 10, 11 are shown on a part of the radial circumferential surface. In addition, a detector 12 is shown, which is arranged at a predetermined distance to the pole wheel 2. The detector 12 is, for example, a detector/sensor based on the XMR and/or Hall measurement method and measures the rotation and/or position of the pole wheel 2 in high resolution.

FIG. 3 shows a detailed schematic of the structure of the pole wheel 2. The pole wheel 2 has a supporting structure 13, for example a ceramic and metallic disc. The hard-metallic layer according to the invention is applied to this supporting structure 13. In the case shown, the hard-metallic layer is applied to the entire radial circumferential surface and to one of the two end faces of the pole wheel. According to a particular embodiment of the invention, the hard-magnetic layer is provided only in the scanning region of the sensor 12. According to a further preferred embodiment of the invention, a protective layer 15 is provided over the hard-magnetic layer to protect the scanned hard-magnetic layer from damage and/or environmental influences.

According to a particular embodiment of the invention, the system-immanent disadvantages of magnetic rotary encoders can be compensated for with the use of pole wheels that use a hard-magnetic layer, in particular a cobalt samarium layer (CoSm), instead of a polymer-based composite layer, preferably without application of a polymer matrix.

CoSm has an excellent temperature resistance with a Curie temperature of more than 700° C. Furthermore, the very homogeneous microcrystalline structure of the layer in combination with a well controllable layer thickness allows very precise magnetisation with an angular accuracy of less than 0.1°. If such pole wheels are combined with the appropriate sensors, resolutions of up to 18 bits can be achieved. This not only makes it possible to achieve accuracies that could previously only be covered by optical systems, but also to achieve a known robustness. The accuracy that can be achieved also meets the criteria for use in electric motors to control the rotors as a replacement for resolvers.

Hollow cathode gas flow sputtering, PVD, PECVD, CVD or plasma spraying, preferably hollow cathode gas flow or PVD method, is used for high-precision application to the substrates. The layer thicknesses range between 1 and 150 μm. Suitable substrates are metallic materials such as steel, stainless steel, copper, brass or aluminium, although non-ferromagnetic materials are preferred.

Another advantage over the state of the art is the insensitivity to organic solvents, oils as well as greases, since in particular no carbon-based polymers are used. Especially in environments with oil mist, which are found in the field of high-performance electric motors and drive trains of e-vehicles, among other things, this innovation represents a decisive added value for increasing efficiency.

Furthermore, it is possible to dispense with the housing and use a combination of a pole wheel that is placed directly on the shaft and a separate analyser unit (bearingless encoders). On the one hand, this makes it possible to integrate the measuring unit directly, e.g. in an electric motor, and on the other hand, no free end of the shaft is required for mounting.

If higher rotation speeds are required, conventional systems either require a support ring on the outside of the pole wheel or gears must be used as signal generators (back-biased arrangement). However, this is at the expense of accuracy; in addition, such a configuration requires a very small distance between the sensor and the wheel, which often cannot be guaranteed due to real-world tolerances.

1. A magnetic signal device for measuring the position of a rotating component of a drive machine, the signal device being coupled in a rotationally fixed manner to the component of the drive machine and the signal device having a supporting element and a magnetizable, hard-magnetic layer deposited on the supporting element from a gas phase directly on the supporting element, wherein at least 75% by weight, preferably at least 85% by weight, particularly preferably at least 90% by weight, based on the composition of the hard-magnetic layer, of the hard-magnetic layer consist of one or more of the following compounds
NdFeB and/or
Co₅Sm and/or
Co₂Sm₁₇
and the hard-magnetic layer has a magnetic remanence of 0.3 T to 1.3 T in its scanning region and after magnetization the hard-magnetic layer has a magnetic structure in the direction of rotation, so that, depending on the angle of rotation of the component, the magnetic structure, for example the magnetic field strength at different heights and/or orientations, can be measured on the hard-magnetic layer via a sensor in order to enable conclusions to be drawn about the rotation and/or position of the component.

2. The magnetic signal device according to claim 1, wherein the hard-magnetic layer has an average thickness of between 10 and 100 μm, preferably more than 15 μm, particularly preferably between 25 and 60 μm, in its scanning region.

3. The magnetic signal device according to claim 1, wherein the supporting structure comprises a non-magnetic, in particular ceramic, material.

4. The magnetic signal device according to claim 1, wherein the supporting structure comprises a metallic material.

5. The magnetic signal device according to claim 1, wherein a further layer, preferably with an average thickness of up to 10 μm, is provided over the scanning region of the hard-magnetic layer as a protective layer for protecting the hard-magnetic layer.

6. The magnetic signal device according to claim 1, wherein the hard-magnetic layer contains further alloying elements from the series of transition metals in its scanning region, preferably Fe and/or Zr and/or Cu.

7. The magnetic signal device according to claim 1, wherein the magnetic signal device is configured as a rotationally symmetrical pole wheel.

8. The magnetic signal device according to claim 1, wherein an angular accuracy of less than or equal to 0.1° between the differently magnetized regions is achievable when the hard-magnetic layer is magnetized.

9. The magnetic signal device according to claim 1, wherein the supporting element is non-magnetic.

10. The magnetic signal device according to claim 1, wherein the hard-magnetic layer has been applied to the supporting element by at least one of the following methods:
hollow cathode gas flow sputtering
hollow cathode sputtering
electroplating
PVD method
CVD method
plasma spraying.

11. A magnetic detection device with the magnetic signal device according to claim 1 and a sensor unit with a sensor working with a XMR and/or Hall measuring method.

12. The magnetic detection device according to claim 11, wherein a distance of 0.1 mm to 3 mm is provided between the sensor and the magnetic signal device.

13. The magnetic detection device according to claim 11, wherein the sensor and the magnetic signal device have a resolution of 10 to 20 bits, in particular on one or more tracks.

14. A method for producing the magnetic signal device according to claim 1, wherein the hard-magnetic layer is applied directly from the gas phase to the supporting element by one of the following methods:
hollow cathode gas flow sputtering
hollow cathode sputtering
electroplating
PVD method
CVD method
plasma spraying.
